(19) United States
(12) Patent Application Publication
(10) Pub. No.: US 2007/0167574 A1
(43) Pub. Date: Jul. 19, 2007

(54) Fluorocarbon rubber with enhanced low temperature properties

(75) Inventor: Edward Hosung Park, Saline, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/332,872

(22) Filed: Jan. 13, 2006

(51) Int. Cl. C08L 27/12

(52) U.S. Cl. 525/199

(57) ABSTRACT

Processable rubber compositions containing a vulcanized elastomeric material dispersed in a matrix of a thermoplastic polymeric material. The vulcanized elastomeric material is a peroxide cure polymeric material containing repeating units derived from fluorine-containing monomers and at least one peroxide cure site monomer. In one embodiment the matrix forms a continuous phase and the vulcanized elastomeric material is in the form of particles forming a non-continuous phase. The compositions are made by combining a radical curing system, a fluorocarbon elastomer material, and a fluoroplastic material, and heating the mixture at a temperature and for a time sufficient to effect vulcanization of the elastomeric material, while mechanical energy is applied to mix the mixture during the heating step. Shaped articles may be readily formed from the rubber compositions according to conventional thermoplastic processes such as blow molding, injection molding, and extrusion. Examples of useful articles include seals, gaskets, O-rings, and hoses.

### FIELD OF THE INVENTION

The present invention relates to thermoprocessable compositions containing cured fluorocarbon elastomers. It also relates to seal and gasket type material made from the compositions and methods for their production by dynamic vulcanization techniques.

### BACKGROUND OF THE INVENTION

Cured elastomeric materials have a desirable set of physical properties typical of the elastomeric state. They show a high tendency to return to their original size and shape following removal of a deforming force, and they retain physical properties after repeated cycles of stretching, including strain levels up to 1000%. Based on these properties, the materials are generally useful for making shaped articles such as seals and gaskets.

Because they are thermoset materials, cured elastomeric materials can not generally be processed by conventional thermoplastic techniques such as injection molding, extrusion, or blow molding. Rather, articles must be fashioned from elastomeric materials by high temperature curing and compression molding. Although these and other rubber compounding operations are conventional and known, they nevertheless tend to be more expensive and require higher capital investment than the relatively simpler thermoplastic processing techniques. Another drawback is that scrap generated in the manufacturing process is difficult to recycle and reuse, which further adds to the cost of manufacturing such articles.

Rubber compositions used for example in automotive applications are exposed to a wide range of environmental conditions, including extremes of temperature in use. In cold climates such compositions can be exposed to temperatures of −20° C. and below. Cold temperatures can cause rubber compositions to freeze, crack or suffer other damage. If the damage from cold temperatures is irreversible, gaskets and other sections can fail, with undesirable consequences.

To meet the demands of low temperature conditions, fluorocarbon elastomers are being developed that are resistant to damage caused by low temperatures. For example, cured elastomers based on copolymers of certain perfluorovinyl ethers have been introduced. Under some laboratory tests, the materials exhibit low temperature stability down to about −40° C.

But the materials still have drawbacks. First, as a thermoset material, the cured fluorocarbon rubber is subject to the processing disadvantages noted above. And while −40° C. is acceptable, in many parts of the world it would be desirable to go down even further to provide better performance overall and in temperature extremes.

An elastomeric or rubber composition that would combine a high level of low temperature resistance with the advantages of thermoplastic processability would represent a significant advance in the art. It would further be desirable to provide methods for formulating chemically resistant rubbers having such advantageous properties.

### SUMMARY OF THE INVENTION

These and other advantages are achieved with a processable rubber composition containing a vulcanized elastomeric material dispersed in a matrix of a thermoplastic polymeric material. The vulcanized elastomeric material comprises a peroxide-cured polymeric material comprising repeating units derived from one or more fluorine-containing monomers, and from low levels of a peroxide cure site monomer that contains at least one of a C—Cl bond, a C—Br bond, a C—I bond, and an olefin. In one embodiment the matrix forms a continuous phase and the vulcanized elastomeric material is in the form of particles forming a non-continuous phase. In various embodiments, the processable compositions exhibit favorable low temperature properties, such as a T100 (ASTM D-1053) below −40° C. and are thermally processed into molded articles having favorable low temperature properties. In preferred embodiments, the T100 of the processable rubber composition of the invention is significantly lower than that of the cured rubber itself.

A method for making a rubber composition comprises combining a radical curing system, a curable elastomeric material having cure sites highly reactive to radical initiators, and a thermoplastic material, and heating the mixture at a temperature and for a time sufficient to effect vulcanization of the elastomeric material while mechanical energy is applied to mix the mixture during the heating step. The elastomeric material is a fluorocarbon polymer and the thermoplastic material comprises a fluorine containing polymeric material that softens and flows upon heating.

Shaped articles may be readily formed from the rubber compositions according to conventional thermoplastic processes such as blow molding, injection molding, and extrusion. Examples of useful articles include seals, gaskets, O-rings, and hoses.

Further areas of applicability of the present invention will become apparent from the detailed description provided hereinafter

### DETAILED DESCRIPTION

The following description of the preferred embodiment(s) is merely exemplary in nature and is in no way intended to limit the invention, its application, or uses.

The headings (such as “Introduction” and “Summary”) used herein are intended only for general organization of topics within the disclosure of the invention, and are not intended to limit the disclosure of the invention or any aspect thereof. In particular, subject matter disclosed in the “Introduction” may include aspects of technology within the scope of the invention, and may not constitute a recitation of prior art. Subject matter disclosed in the “Summary” is not an exhaustive or complete disclosure of the entire scope of the invention or any embodiments thereof.

The citation of references herein does not constitute an admission that those references are prior art or have any relevance to the patentability of the invention disclosed herein. All references cited in the Description section of this specification are hereby incorporated by reference in their entirety.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations of the stated features. Specific Examples are provided for illustrative purposes of how to make, use and practice the compositions and methods of this invention and, unless explicitly stated otherwise, are not intended to be a representation that given embodiments of this invention have, or have not, been made or tested.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the word “include,” and its variants, is intended to be non-limiting, such that recitation of items in a list is not to the exclusion of other like items that may also be useful in the materials, compositions, devices, and methods of this invention.

As used herein, elastomer refers, according to context, to either a non-cured or a cured fluorocarbon elastomer. At times, descriptors such as “cured”, “uncured”, and “partially cured”, are added for clarity. Uncured elastomers are sometimes referred to as elastomer gums. The terms “cured elastomer”, “peroxide cured fluorocarbon elastomer”, and the like describe the product of curing or crosslinking the uncured elastomer or elastomer gum with a radical curing system.

When exposed to low temperatures, rubbers are subject to damage or loss of strength or other desirable physical properties. Normally the rubbers degrade over time when exposed to such fluids. The degradation is expressed as a change in physical parameters such as tensile strength, modulus, hardness, elongation at break, and others. According to various embodiments of the invention, it has been found that low temperature stability of shaped rubber articles such as seals is enhanced when fluorocarbon rubbers are cured by radical curing systems in the presence of thermoplastic materials as discussed herein. The processable compositions are made into various molded articles such as seals, gaskets, o-rings, hoses, and the like. The molded articles exhibit an advantageous combination of elastomeric properties. Furthermore, in various embodiments, the low temperature properties of articles made from the processable compositions of the invention are better than those of articles made of the cured fluorocarbon rubbers themselves. A representative parameter illustrating the low temperature properties is the T100 as defined in ASTM D-1053.

In one embodiment, the invention provides processable rubber compositions that contain a vulcanized elastomeric material dispersed in a matrix. The vulcanized elastomeric material is a peroxide cured fluorocarbon elastomer comprising repeating units derived from at least one fluorine containing olefinic monomer and at least one cure site monomer, with the cure site monomer comprising at least one of a C—Cl bond, a C—Br bond, a C—I bond, and an olefin. The at least one fluorine containing olefinic monomer optionally includes a perfluorovinylether, and normally includes additional fluorine monomers other than the perfluorovinylether. The matrix comprises a thermoplastic polymeric material. In various embodiments, the thermoplastic polymer material is a fluorine containing material, also called a fluoroplastic. In various embodiments, the vulcanized elastomeric material is a polymeric material containing repeating units derived from vinylidene fluoride and other monomers, or from tetrafluoroethylene and at least one C₂₋₄ olefin. The vulcanized materials further contain crosslinks resulting from the reaction of peroxide curing agents and co-agents with radical cure sites in the polymeric material.

In one aspect, the matrix forms a continuous phase and the vulcanized elastomeric material is in the form of particles forming a non-continuous phase. In another aspect, the elastomeric material and the matrix form co-continuous phases.

The processable rubber compositions of the invention are readily processable by conventional plastic processing techniques. In another embodiment, shaped articles are provided comprising the vulcanized elastomeric materials dispersed in a thermoplastic matrix. Shaped articles of the invention include, without limitation, seals, O-rings, gaskets, and hoses.

In another embodiment, shaped articles such as rubber sealing members, O-rings, gaskets, and the like are prepared by thermoplastic processing of processable rubber compositions such as described above. In various embodiments, the cured fluorocarbon elastomer in the shaped article is a fluoropolymer containing interpolymerized units derived from
(i) tetrafluoroethylene;
(ii) vinylidene fluoride;
(iii) at least one ethylenically unsaturated monomer of the formula CF₂═CFR_{f}, wherein R_{f} is perfluoroalkyl of 1 to 8 carbon atoms; and
(iv) a cure site monomer comprising at least one functional group selected from the group consisting of a C—Cl bond, a C—Br bond, a C—I bond, and an olefin.

In a preferred embodiment, the cured fluorocarbon elastomer further comprises interpolymerized units derived from a perfluorovinyl ether. Illustratively, the perfluorovinyl ether has a formula CF₂═CF—(OCF₂CF(R_{f}))ₐOR′_{f} wherein R_{f} is a perfluoroalkyl of from 1 to 8 carbon atoms, R′_{f} is a perfluoroaliphatic from 1 to 8 carbons, and a is from 0 to 3. Examples of perfluoroaliphatics for R′_{f} include perfluoroalkyl and perfluoroalkoxyalkyl. In various embodiments, the thermoplastic matrix comprises a fluoroplastic, such as a polymer or copolymer of vinylidene fluoride or a co-polymer of ethylene and chlorotrifluoroethylene.

In another embodiment, a method is provided for improving the low temperature properties of a processable rubber composition or a shaped article containing a cured fluorocarbon elastomer. The method involves dynamically vulcanizing a fluorocarbon elastomer that contains radical cure sites and repeating units derived from at least one fluorine containing olefinic monomer. Dynamic vulcanization involves mixing elastomer and thermoplastic components in the presence of a curing system and heating during the mixing to effect cure of the elastomeric component. The dynamic vulcanization takes place in the presence of a thermoplastic polymeric material and a radical curing system to form a processable rubber composition containing from about 20% to about 80% by weight of the cured fluorocarbon elastomer, based on the total weight of the cured elastomer and thermoplastic matrix.

In various embodiments, the low temperature properties of compositions containing intrinsically low temperature stable fluorocarbon elastomers are improved further yet by dynamically vulcanizing the fluorocarbon elastomer in a thermoplastic. Resulting compositions contain from about 20-80% by weight, preferably 30-80% by weight, preferably 30-70% by weight, preferably 40-70% by weight, and more preferably 40-60% by weight of the cured fluorocarbon elastomer, based on the total weight of the cured elastomer and thermoplastic. In various embodiments, the fluorocarbon elastomer is present as amorphous cured particles dispersed in a continuous phase, wherein the continuous phase is made of the thermoplastic material; the thermoplastic material forms a matrix in which the cured fluorocarbon elastomer is dispersed by the process of dynamic vulcanization.

In another embodiment, shaped articles such as rubber sealing members, O-rings, gaskets and the like are prepared by thermoplastic processing of processable rubber compositions such as described above. In various embodiments, the cured fluorocarbon elastomer in the shaped article is cured by a radical curing system and contains interpolymerized units derived from
(a) a perfluorovinyl ether of the formula CF₂═CF—(OCF₂CF(R_{f}))ₐOR′_{f} where in R_{f} is perfluoroalkyl of 1 to 8 carbon atoms, R′_{f} is perfluoroalkyl or perfluoroalkoxyalkyl of 1 to 8 carbons, and a is from 0 to 3;
(b) at least one fluorine containing olefinic monomer other than the perfluorovinyl ether; and
(c) a cure site monomer comprising at least one functional group consisting of a C—Cl bond, a C—I bond, and an olefin.

In various embodiments, the processable rubber compositions are prepared by dynamically vulcanizing the fluorocarbon elastomer in the presence of the thermoplastic. In one embodiment, the elastomeric material and thermoplastic material are mixed for a time and at a shear rate sufficient to form a dispersion of the elastomeric material in a continuous thermoplastic phase. Thereafter, a radical curing system such as a peroxide and crosslinking co-agent is added to the dispersion of elastomeric material and thermoplastic material while continuing the mixing. Finally, the dispersion is heated while continuing to mix to produce the processable rubber composition of the invention.

When rubber materials are exposed to low temperatures, either in use or as part of periodic temperature cycling, the question arises whether the rubber compounds possess sufficient strength and other physical properties to continue acceptable operation. A number of changes in physical properties of rubber are observed as temperature decreases. In general, rubbers become stiffer and more brittle as temperature is lowered. In some cases, the properties return to the ambient value as the temperature is again raised after a temporary exposure to a low temperature. However, in many cases, a rubber is subject to permanent irreversible property degradation on cycling or to diminished physical properties at low temperatures of use. For all of these reasons, the industry has accepted certain standards for low temperature properties that serve as specifications for particular uses.

In the rubber industry, an accepted measure of low temperature properties, which measures the stiffness of rubber compositions at low temperatures, is the parameter T100, as determined in ASTM Method D1053-92A. T100 designates the temperature at which the relative modulus or the tortional stiffness ratio is measured to be 100. In a sense, the T100 represents the temperature at which the relative modulus of the material is 100 times what it was at 23° C. or room temperature.

For automotive use, it is desirable to use rubber materials as seals, gaskets, and the like that exhibit a T100 of −20° C. or less. Recently, commercial cured fluorocarbon rubbers were introduced to the market that exhibit a T100 to −40° C. Commercial examples of fluorocarbon rubbers that are said to have favorable low temperature properties as reflected by T100 values of −20° C. or less include the Viton® GL Series and a new proprietary LTFE® series from Dyneon. Until now, however, none of the commercially available materials exhibit a T100 below −40° C.

The current invention is based in part on the discovery that fluorocarbon elastomer compositions can be made that have T100, measured by ASTM D1053-92A below −40° C. and even down to about −80° C. It has been observed that the low temperature fluorocarbon elastomer compositions made by dynamically vulcanizing a fluorocarbon elastomer—preferably an intrinsically low temperature fluorocarbon elastomer such as those now commercially available—in the presence of a thermoplastic results in rubber compositions that have a T100 lower than that of either the elastomer or the thermoplastic from which the composition is made.

In various embodiments, it has been observed that the lowering of the T100 of the composition occurs when the cured fluorocarbon elastomer content of the composition is above about 20% by weight and less than about 80% by weight, based on the total weight of rubber and thermoplastic. In one aspect, the lowering is observed for compositions having sufficiently high thermoplastic (more than about 20%) for the thermoplastic to form a continuous phase in which the cured fluoroelastomer is dispersed. Such a “phase inversion” can be observed and visualized with techniques such as atomic force microscopy. In various aspects, compositions containing at least 40%, and preferably at least 50% of cured elastomer are preferred, as those compositions exhibit the best combination of elastomeric properties. All percentages are based on the total amount of cured elastomer and thermoplastic, and do not take into account any filler or other additives that are preferably additionally present in the processable rubber compositions and shaped articles of the invention. On the high thermoplastic end (say about 80% or greater), the compositions and shaped articles are less preferred due to their low elastomer content, even though a synergistic lowering of T100 might still be observed.

In various embodiments, the methods and compositions of the invention lead to particular advantage when fluorocarbon rubbers such as those recently made available to the market are vulcanized in thermoplastic. Further details and advantages associated with various embodiments of the invention are given in more detail below.

Suitable fluorocarbon elastomers include those that are curable by radical curing systems, and contain so-called radical cure sites that react preferably with the curing system to yield a crosslinked or vulcanized elastomer. Various types of peroxide curable fluoroelastomers may be used. One classification of fluoroelastomers is given in ASTM-D 1418, “Standard practice for rubber and rubber latices-nomenclature”. The designation FKM is given for fluororubbers that utilize vinylidene fluoride as a co-monomer. Several varieties of FKM fluoroelastomers are commercially available. A first variety may be chemically described as a copolymer of hexafluoropropylene and vinylidene fluoride. This is a dipolymer type of elastomer and is exemplified by the Viton® A series of rubbers from DuPont/Dow. These FKM elastomers tend to have an advantageous combination of overall properties. Some commercial embodiments are available with about 66% by weight fluorine. Another type of FKM elastomer may be chemically described as a terpolymer of tetrafluoroethylene, hexafluoropropylene, and vinylidene fluoride. These terpolymers are exemplified by the Viton® B series. Such elastomers tend to have high heat resistance and good resistance to aromatic solvents. They are commercially available with, for example 68-69.5% by weight fluorine. In a preferred embodiment, the fluoroelastomer of the invention contains, in addition to those discussed above, repeating units derived from a variety of perfluorovinyl ethers, further described below. A non-limiting example includes a terpolymer of tetrafluoroethylene, a fluorinated vinyl ether, and vinylidene fluoride. Such elastomers tend to have improved low temperature performance. In various embodiments, they are available with 62-68% by weight fluorine. A third type of FKM elastomer is described as a terpolymer of tetrafluoroethylene, C₂₋₄ olefin (such as ethylene or propylene), and vinylidene fluoride. Such FKM elastomers tend to have improved base resistance. Some commercial embodiments contain about 67% weight fluorine. Another non-limiting example is a pentapolymer of tetrafluoroethylene, hexafluoropropylene, ethylene, a fluorinated vinyl ether and vinylidene fluoride. Such elastomers typically have improved base resistance and have improved low temperature performance.

Preferred fluorocarbon elastomers include copolymers of one or more fluorine-containing monomers, chiefly vinylidene fluoride (VDF), hexafluoropropylene (HFP), tetrafluoroethylene (TFE), and perfluorovinyl ethers (PFVE). In various embodiments, elastomers containing PFVE (as described further below) tend to have favorable low temperature properties, characterized for example by a T100 of −20° C. or even down to −40° C. (as measured on the cured rubber itself). In various embodiments, the copolymers may also contain repeating units derived from olefins such as ethylene (Et) and propylene (Pr).

Non-limiting examples of fluorocarbon elastomers that contain perfluorovinyl ethers (PFVE) include VDF/HFP/PFVE/CSM, VDF/HFP/TFE/PFVE/CSM, VDF/PFVE/TFE/CSM, TFE/Pr/PFVE/CSM, TFE/PrNVDF/PFVE/CSM, TFE/Et/PFVE/VDF/CSM, TFE/Et/PFVE/CSM and TFE/PFVE/CSM, where CSM represents the peroxide cure site monomers, described in detail below. The elastomer designation gives the monomers from which the elastomer gums are synthesized. Commercial examples include Viton® G.L.T. series rubbers, Viton® GFLT series rubbers, and Viton® ETP series rubbers. In some embodiments, the elastomer gums have viscosities that give a Mooney viscosity in the range generally of 15-160 (ML1+10, large rotor at 121° C.), which can be selected for a combination of flow and physical properties. Typically, the elastomers have a T100 of −20° C. or lower. Elastomer suppliers include Dyneon (3M), Asahi Glass Fluoropolymers, Solvay/Ausimont, DuPont, and Daikin.

The fluorocarbon elastomers and cured fluorocarbon elastomers used in the compositions and methods of the invention contain repeating units derived from one or more fluorine containing olefinic monomers as described above, and further contain repeating units derived from so-called peroxide cure site monomers, which are described in further detail below. The repeating units are derived from the corresponding monomers in the sense that, as the structure of the polymer results from a copolymerization of the olefinic monomers, the resulting structure contains repeating units that are determined by the structures of the copolymerizing monomers. In the cured elastomers, at least some of the repeating units derived from the cure site monomers contain so-called peroxide crosslinks. In one embodiment, the peroxide crosslinks are formed by the reaction of polyolefinic co-agents with radicals on the cure site monomers induced by the action of the peroxide component of the radical curing system.

The molecular weight of the fluoroelastomer of the invention varies over a wide range. Thus it may vary from low molecular weight to ultra high molecular weight. Furthermore, the fluoropolymers may have either a generally unimodal or a multimodal molecular weight distribution.

The molecular weight of an elastomeric fluoropolymer according to the invention may be described by its Mooney viscosity (ML). This value can be measured according to ASTM D 1646 using a one minute pre-heat and a 10 minute test at 121° C.

The fluorocarbon elastomers of the invention typically exhibit a glass transition tempurature (T_{g}) and a melting point of less than 120° C. The elastomers are essentially amorphous and are curable using known techniques with radical curing systems such as a peroxide system. By essentially amorphous it is meant that the polymer may contain some crystallinity e.g., less than 10%.

In a preferred embodiment, the fluoroelastomer is a fluoropolymer derived from interpolymerized units of cure site monomers and from (i) TFE, (ii) VDF, (iii) at least one ethylenically unsaturated monomer of the formula CF₂═CFR_{f} where R_{f} is perfluoroalkyl of 1 to 8, preferably 1 to 3, carbon atoms, and optionally from a perfluorovinyl ether of the formula CF₂═CF—(OCF₂CF(R_{f}))ₐOR′_{f} where R_{f} is a perfluoroalkyl of 1 to 8, preferably 1 to 3, carbon atoms, R′_{f} is a perfluoroaliphatic, preferably perfluoroalkyl or perfluoroalkoxyalkyl, of 1 to 8, preferably 1-3, carbon atoms, and a has a value of from 0 to 3.

Preferably the elastomeric polymers of the invention comprise interpolymerized units derived from
20 to 50 weight percent (more preferably 30 to 46 weight percent; most preferably 33 to 46 weight percent) of (i);
10 to 35 weight percent (more preferably 15 to 30 weight percent; most preferably 17 to 28 weight percent) of (ii);
20 to 50 weight percent (more preferably from 25 to 45 weight percent; most preferably from 26 to 42 weight percent) of (iii); and
optionally from 0.1 to 15 weight percent (more preferably from 0.5 to 10 weight percent; most preferably from 0.5 to 7 weight percent) of the perfluorovinyl ether of the formula CF₂═CF—(OCF₂CF(R_{f}))ₐOR′ₜ.

Non-limiting examples of the perfluorovinyl ether include

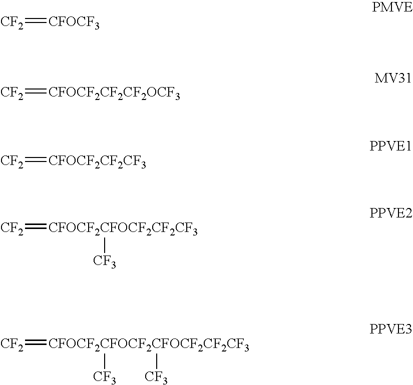

In various embodiments, preferred perfluorovinyl ethers include PPVE1 and PPVE2.

A preferred species of a quadpolymer of the invention contains interpolymerized units derived from TFE, VDF, HFP and the perfluorovinyl ether wherein the value of “a” is 0, 1 or 2.

Non-limiting examples of preferred fluorocarbon elastomers include the LTFE series from Dyneon.

In various embodiments, the fluoroelastomers of the compositions of the invention contain repeating units derived from peroxide cure site monomers. In various embodiments, the fluorocarbon elastomers contain up to 5 mole % and preferably up to 3 mole % of repeating units derived from the so-called cure site monomers. In one embodiment, the cure site repeating units are derived from halogen-containing olefin monomers, wherein the halogen is chlorine, bromine, iodine, or combinations of any of them. If used, preferably the repeating units of a halogen-containing olefin are present in a level to provide at least about 0.05% halogen in the polymer, preferably 0.3% halogen or more. In a preferred embodiment, the total weight of halogen in the polymer is 1.5 wt. % or less.

The cure site monomers provide sites on the elastomeric material that react at a high rate with radical initiators such as peroxides. The cure site monomer sites react faster with the curing system than other parts of the elastomer. Crosslinking thus occurs preferentially at the cure site monomers. It is believed that this crosslinking action is responsible at least in part for development of elastomeric properties in the elastomer. The cure site monomers are preferably selected from the group consisting of brominated, chlorinated, and iodinated olefins; brominated, chlorinated, and iodinated unsaturated ethers; and non-conjugated dienes.

In preferred embodiments, the fluoroelastomers comprise at least one halogenated cure site or a reactive double bond resulting from the presence of a copolymerizied unit of a non-conjugated diene. The double bond of the cure site monomer is referred to herein as an olefin. Functional groups associated with the cure sites thus include a carbon bromine (C—Br) bond, a carbon iodine (C—I) bond, a carbon chlorine (C—Cl) bond, and an olefin. In various embodiments, halogenated cure sites are provided by copolymerized cure site monomers and/or by halogen atoms that are present at terminal positions of the fluoroelastomer polymer chain. Generically, the halogenated cure sites are said to be repeating units derived from a cure site monomer. Co-polymerized cure site monomers, reactive double bonds, and halogenated end groups are capable of reacting to form crosslinks, especially under conditions of catalysis or initiation by the action of peroxides.

As is clear from this discussion, the repeating units of an uncured elastomer derived from the cure site monomers contain one or more of those functional groups. On the other hand, in cured elastomers, some of the functional groups will be reacted with the curing system. In both cases, it is said that the elastomer contains repeating units derived from peroxide cure site monomers.

Brominated cure site monomers may contain other halogens, preferably fluorine. Examples are bromotrifluoroethylene, 4-bromo-3,3,4,4-tetrafluorobutene-1 and others such as vinyl bromide, 1-bromo-2,2-difluoroethylene, perfluoroally bromide, 4-bromo-1,1,2-trifluorobutene, 4-bromo-1,3,3,4,4,-hexafluorobutene, 4-bromo-3-chloro-1,1,3,4,4-pentafluorobutene, 6-bromo-5,5,6,6-tetrafluorohexene, 4-bromoperfluorobutene-1 and 3,3-difluoroallyl bromide. Brominated unsaturated ether cure site monomers useful in the invention include ethers such as 2-bromo-perfluoroethyl perfluorovinyl ether and fluorinated compounds of the class CF₂ Br—R_{f} —O—CF═CF₂ (R_{f} is perfluoroalkylene), such as CF₂ BrCF₂ O—CF═CF₂, and fluorovinyl ethers of the class ROCF═CFBr or ROCBr═CF₂, where R is a lower alkyl group or fluoroalkyl group, such as CH₃OCF═CFBr or CF₃ CH₂ OCF═CFBr.

Iodinated olefins may also be used as cure site monomers. Suitable iodinated monomers include iodinated olefins of the formula: CHR═CH-Z-CH₂CHR—I, wherein R is —H or —CH₃; Z is a C₁, —C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂ CF₂ CF₂)ₙOCF═CF₂ and ICH₂ CF₂ O[CF(CF₃)CF₂O]ₙ CF═CF₂, and the wherein n=1-3, such as disclosed in U.S. Pat. No. 5,717,036. In addition, suitable iodinated cure site monomers including iodoethylene, 4-iodo-3,3,4,4-tetrafluorobutene-1; 3-chloro-4-iodo-3,4,4-trifluorobutene; 2-iodo-1,1,2,2-tetrafluoro-1-(vinyloxy)ethane; 2-iodo-1-(perfluorovinyloxy)-1,1,2,2-tetrafluoroethylene; 1,1,2,3,3 3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045.

Examples of non-conjugated diene cure site monomers include 1,4-pentadiene, 1,5-hexadiene, 1,7-octadiene and others, such as those disclosed in Canadian Patent 2,067,891. A suitable triene is 8-methyl-4-ethylidene-1,7-octadiene.

Of the cure site monomers listed above, preferred compounds include 4-bromo-3,3,4,4-tetrafluorobutene-1; 4-iodo-3,3,4,4-tetrafluorobutene-1; and bromotrifluoroethylene.

Additionally, or alternatively, cure site monomers and repeating units derived from them contain iodine, bromine or mixtures thereof present at the fluoroelastomer chain ends as a result of the use of chain transfer or molecular weight regulating agents during preparation of the fluoroelastomers. Such agents include iodine-containing compounds that result in bound iodine at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,4-diiodoperfluorobutane; 1,6-diiodoperfluorohexane; 1,3-diiodo-2-chloroperfluoropropane; 1,2-di(iododifluoromethyl)perfluorocyclobutane; monoiodoperfluoroethane; monoiodoperfluorobutane; and 2-iodo-1-hydroperfluoroethane. Particularly preferred are diiodinated chain transfer agents. Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Fluorocarbon elastomeric materials used to make the processable rubber compositions of the invention may typically be prepared by free radical emulsion polymerization of a monomer mixture containing the desired molar ratios of starting monomers including cure site monomers. Initiators are typically organic or inorganic peroxide compounds, and the emulsifying agent is typically a fluorinated acid soap. The molecular weight of the polymer formed may be controlled by the relative amounts of initiators used compared to the monomer level and the choice of transfer agent if any. Typical transfer agents include carbon tetrachloride, methanol, and acetone. The emulsion polymerization may be conducted under batch or continuous conditions. Such fluoroelastomers are commercially available as noted above. Mixtures and combination of thermoplastics can also be used.

In various embodiments, dynamically vulcanizing the elastomers described above in a variety of thermoplastic polymer materials leads to processable rubber compositions (and the shaped articles made from the compositions) having low temperature properties superior to those of the vulcanized elastomers themselves.

A wide variety of thermoplastic polymeric materials (“thermoplastics”) can be used in the invention. Suitable thermoplastics include fluoroplastics as well as non-fluorine containing materials. In one embodiment, the thermoplastic polymeric material used is a thermoplastic elastomer. Preferred thermoplastic elastomers include those having a crystalline melting point of 120° C. or higher, preferably 150° C. or higher, and more preferably 200° C. or higher.

Thermoplastic elastomers have some physical properties of rubber, such as softness, flexibility and resilience, but can be processed like thermoplastics. A transition from a melt to a solid rubber-like composition occurs fairly rapidly upon cooling. This is in contrast to convention elastomers, which hardens slowly upon heating. Thermoplastic elastomers may be processed on conventional plastic equipment such as injection molders and extruders. Scrap may generally be readily recycled.

Thermoplastic elastomers have a multi-phase structure, wherein the phases are generally intimately mixed. In many cases, the phases are held together by graft or block copolymerization. At least one phase is made of a material that is hard at room temperature but fluid upon heating. Another phase is a softer material that is rubber like at room temperature.

Some thermoplastic elastomers have an A-B-A block copolymer structure, where A represents hard segments and B is a soft segment. Because most polymeric material tend to be incompatible with one another, the hard and soft segments of thermoplastic elastomers tend to associate with one another to form hard and soft phases. For example, the hard segments tend to form spherical regions or domains dispersed in a continuous elastomer phase. At room temperature, the domains are hard and act as physical crosslinks tying together elastomeric chains in a 3-D network. The domains tend to lose strength when the material is heated or dissolved in a solvent.

Other thermoplastic elastomers have a repeating structure represented by (A-B)ₙ, where A represents the hard segments and B the soft segments as described above.

Many thermoplastic elastomers are known. They in general adapt either the A-B-A triblock structure or the (A-B)ₙ repeating structure. Non-limiting examples of A-B-A type thermoplastic elastomers include polystyrene/polysiloxane/polystyrene, polystyrene/polyethylene-co-butylene/polystyrene, polystyrene/polybutadiene polystyrene, polystyrene/polyisoprene/polystyrene, poly-α-methyl styrene/polybutadiene/poly-α-methyl styrene, poly-α-methyl styrene/polyisoprene/poly-α-methyl styrene, and polyethylene/polyethylene-co-butylene/polyethylene.

Non-limiting examples of thermoplastic elastomers having a (A-B)ₙ repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Among the most common commercially available thermoplastic elastomers are those that contain polystyrene as the hard segment. Triblock elastomers are available with polystyrene as the hard segment and either polybutadiene, polyisoprene, or polyethylene-co-butylene as the soft segment. Similarly, styrene butadiene repeating co-polymers are commercially available, as well as polystyrene/polyisoprene repeating polymers.

In a preferred embodiment, a thermoplastic elastomer is used that has alternating blocks of polyamide and polyether. Such materials are commercially available, for example from Atofina under the Pebax® trade name. The polyamide blocks may be derived from a copolymer of a diacid component and a diamine component, or may be prepared by homopolymerization of a cyclic lactam. The polyether block is generally derived from homo- or copolymers of cyclic ethers such as ethylene oxide, propylene oxide, and tetrahydrofuran.

The thermoplastic polymeric material may also be selected from among solid, generally high molecular weight, plastic materials. In one embodiment, the materials are crystalline or semi-crystalline polymers, preferably having a crystallinity of at least 25 percent as measured by differential scanning calorimetry. Amorphous polymers with a suitably high glass transition temperature are also acceptable as the thermoplastic polymeric material. In a preferred embodiment, the thermoplastic has a melt temperature or a glass transition temperature in the range from about 80° C. to about 350° C., but the melt temperature should generally be lower than the decomposition temperature of the thermoplastic vulcanizate. In various embodiments, the melting point of crystalline or semi-crystalline polymers is 120° C. or higher, preferably 150° C. or higher, and more preferably 200° C. or higher. Suitable thermoplastic materials include both fluoroplastics and non-fluoroplastics.

Non-limiting examples of thermoplastic polymers include polyolefins, polyesters, nylons, polycarbonates, styrene-acrylonitrile copolymers, polyethylene terephthalate, polybutylene terephthalate, polyamides including aromatic polyamides, polystyrene, polystyrene derivatives, polyphenylene oxide, polyoxymethylene, and fluorine-containing thermoplastics. Polyolefins are formed by polymerizing α-olefins such as, but not limited to, ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another α-olefin such as 1-butene, 1-hexene, 1-octene, 2-methyl-1-propene, 3-methyl-1-pentene, 4-methyl-1-pentene, 5-methyl-1-hexene or mixtures thereof are also contemplated. These homopolymers and copolymers, and blends of them, may be incorporated as the thermoplastic polymeric material of the invention.

Polyester thermoplastics contain repeating ester linking units in the polymer backbone. In one embodiment, they contain repeating units derived from low molecular weight diols and low molecular weight aromatic diacids. Non-limiting examples include the commercially available grades of polyethylene terephthalate and polybutylene terephthalate. Alternatively, the polyesters may be based on aliphatic diols and aliphatic diacids. Exemplary here the copolymers of ethylene glycol or butanediol with adipic acid. In another embodiment, the thermoplastic polyesters are polylactones, prepared by polymerizing a monomer containing both hydroxyl and carboxyl functionality. Polycaprolactone is a non-limiting example of this class of thermoplastic polyester.

Polyamide thermoplastics contain repeating amide linkages in the polymer backbone. In one embodiment, the polyamides contain repeating units derived from diamine and diacid monomers such as the well known nylon 66, a polymer of hexamethylene diamine and adipic acid. Other nylons have structures resulting from varying the size of the diamine and diacid components. Non-limiting examples include nylon 610, nylon 612, nylon 46, and nylon 6/66 copolymer. In another embodiment, the polyamides have a structure resulting from polymerizing a monomer with both amine and carboxyl functionality. Non-limiting examples include nylon 6 (polycaprolactam), nylon 11, and nylon 12.

Other polyamides made from diamine and diacid components include the high temperature aromatic polyamides containing repeating units derived from diamines and aromatic diacids such as terephthalic acid. Commercially available examples of these include PA6T (a copolymer of hexanediamine and terephthalic acid), and PA9T (a copolymer of nonanediamine and terephthalic acid), sold by Kuraray under the Genestar tradename. For some applications, the melting point of some aromatic polyamides may be higher than optimum for thermoplastic processing. In such cases, the melting point may be lowered by preparing appropriate copolymers. In a non-limiting example, in the case of PA6T, which has a melting temperature of about 370° C., it is possible to in effect lower the melting point to below a moldable temperature of 320° C. by including an effective amount of a non-aromatic diacid such as adipic acid when making the polymer.

In another preferred embodiment, an aromatic polyamide is used based on a copolymer of an aromatic diacid such as terephthalic acid and a diamine containing greater than 6 carbon atoms, preferably containing 9 carbon atoms or more. The upper limit of the length of the carbon chain of the diamine is limited from a practical standpoint by the availability of suitable monomers for the polymer synthesis. As a rule, suitable diamines include those having from 7 to 20 carbon atoms, preferably in the range of 9 to 15 carbons, and more preferably in the range from 9 to 12 carbons. Preferred embodiments include C9, C10, and C11 diamine based aromatic polyamides. It is believed that such aromatic polyamides exhibit an increase level of solvent resistance based on the oleophilic nature of the carbon chain having greater than 6 carbons. If desired to reduce the melting point below a preferred molding temperature (typically 320° C. or lower), the aromatic polyamide based on diamines of greater than 6 carbons may contain an effective amount of a non-aromatic diacid, as discussed above with the aromatic polyamide based on a 6 carbon diamine. Such effective amount of diacid should be enough to lower the melting point into a desired molding temperature range, without unacceptably affecting the desired solvent resistance properties.

Other non-limiting examples of high temperature thermoplastics include polyphenylene sulfide, liquid crystal polymers, and high temperature polyimides. Liquid crystal polymers are based chemically on linear polymers containing repeating linear aromatic rings. Because of the aromatic structure, the materials form domains in the nematic melt state with a characteristic spacing detectable by x-ray diffraction methods. Examples of materials include copolymers of hydroxybenzoic acid, or copolymers of ethylene glycol and linear aromatic diesters such as terephthalic acid or naphthalene dicarboxylic acid.

High temperature thermoplastic polyimides include the polymeric reaction products of aromatic dianhydrides and aromatic diamines. They are commercially available from a number of sources. Exemplary is a copolymer of 1,4-benzenediamine and 1,2,4,5-benzenetetracarboxylic acid dianhydride.

In a preferred embodiment, the thermoplastic polymeric material comprises a fluorocarbon thermoplastic polymer, also referred to as a “fluoroplastic.” Commercial embodiments are available that contain 59 to 76% by weight fluorine. They may either be fully fluorinated or partially fluorinated. In various other preferred embodiments, the thermoplastic is selected from thermoplastic elastomers, high molecular weight plastic materials, and other thermoplastic polymeric materials that do not contain fluorine. Mixtures of fluoroplastics and non-fluoroplastics may also be used.

Fully fluorinated thermoplastic polymers include copolymers of tetrafluoroethylene and perfluoroalkyl vinyl ethers. The perfluoroalkyl group is preferably of 1 to 6 carbon atoms. Examples of copolymers are PFA (copolymer of TFE and perfluoropropyl vinyl ether) and MFA (copolymer of TFE and perfluoromethyl vinyl ether). Other examples of fully fluorinated thermoplastic polymers include copolymers of TFE with perfluoro olefins of 3 to 8 carbon atoms. Non-limiting examples include FEP (copolymer of TFE and hexafluoropropylene).

Partially fluorinated thermoplastic polymers include E-TFE (copolymer of ethylene and TFE), E-CTFE (copolymer of ethylene and chlorotrifluoroethylene), and PVDF (polyvinylidene fluoride). A number of thermoplastic copolymers of vinylidene fluoride are also suitable thermoplastic polymers for use in the invention. These include, without limitation, copolymers with perfluoroolefins such as hexafluoropropylene, and copolymers with chlorotrifluoroethylene. Thermoplastic terpolymers may also be used. These include thermoplastic terpolymers of TFE, HFP, and vinylidene fluoride. Fully fluorinated fluoroplastics are characterized by relatively high melting points, when compared to the vinylidene fluoride based thermoplastics that are also included in the fluoroplastic blend of the invention. As examples, PFA has a melting point of about 305° C., MFA has a melting point of 280-290° C., and FEP has a melting point of about 260-290° C. The melting point of individual grades depends on the exact structure, processing conditions, and other factors, but the values given here are representative.

Partially fluorinated fluoroplastics such as the vinylidene fluoride homo- and copolymers described above have relatively lower melting points than the fully fluorinated fluoroplastics. For example, polyvinylidene fluoride has a melting point of about 160-170° C. Some copolymer thermoplastics have an even lower melting point, due to the presence of a small amount of co-monomer. For example, a vinylidene fluoride copolymer with a small amount of hexafluoropropylene, exemplified in a commercial embodiment such as the Kynar Flex series, exhibits a melting point in the range of about 105-160° C., and typically about 130° C. These low melting points lead to advantages in thermoplastic processing, as lower temperatures of melting lead to lower energy costs and avoidance of the problem of degradation of cured elastomers in the compositions.

The fluorocarbon elastomers described above are dynamically cured in the presence of the thermoplastic polymeric material and a radical curing system. The radical curing system contains a radical initiator and a crosslinking co-agent. The radical initiator is believed to function by first extracting a hydrogen or halogen atom from the fluorocarbon elastomer to create a free radical that can be crosslinked. It is believed that the cure site monomers described above provide sites that react with the radical initiator at an accelerated rate, so that subsequent crosslinking described below occurs mainly at the cure site monomers. Crosslinking co-agents are normally included in the radical curing system. They contain at least two sites of olefinic unsaturation, which react with the free radical on the fluorocarbon elastomer molecule generated by reaction with the initiator.

In various embodiments, the initiators have peroxide functionality. As examples of initiators, a wide range of organic peroxides is known and commercially available. The initiators, including the organic peroxides, are activated over a wide range of temperatures. The activation temperature may be described in a parameter known as half-life. Typically values for half-lives of, for example, 0.1 hours, 1 hour, and 10 hours are given in degrees centigrade. For example a T_{1/2} at 0.1 hours of 143° C. indicates that at that temperature, half of the initiator will decompose within 0.1 hours. Organic peroxides with a T_{1/2} at 0.1 hours from 118° C. to 228° C. are commercially available. Such peroxides have a half-life of at least 0.1 hours at the indicated temperatures. The T_{1/2} values indicate the kinetics of the initial reaction in crosslinking the fluorocarbon elastomers, that is decomposition of the peroxide to form a radical containing intermediate.

In some embodiments, it is preferred to match the T_{1/2} of the initiator such as an organic peroxide to the temperature of the molten material into which the curing composition is to be added. In various embodiments, the initiator has a thermal stability such that the half-life is at least 0.1 hours at temperatures of 180° C. or higher. In other embodiments, suitable initiators have a half-life of 0.1 hours at 190° C. or higher, or at temperatures of 200° C. or higher. Non-limiting examples of peroxides and their T_{1/2} for a half-life of 0.1 hours include Trigonox 145-E85 (T_{1/2}=182° C.), Trigonox M55 (T_{1/2}=183° C.), Trigonox K-90 (T_{1/2}=195° C.), Trigonox A-W70 (T_{1/2}=207° C.), and Trigonox TAHP-W85 (T_{1/2}=228° C.). A non-limiting example of a non-peroxide initiator is Perkadox-30 (T_{1/2}=284° C.). The Trigonox and Perkadox materials are commercial or developmental products of AkzoNobel.

Non-limiting examples of commercially available organic peroxides for initiating the cure of fluorocarbon elastomers include butyl 4,4-di-(tert-butylperoxy)valerate; tert-butyl peroxybenzoate; di-tert-amyl peroxide; dicumyl peroxide; di-(tert-butylperoxyisopropyl)benzene; 2,5-dimethyl-2,5-di(tert-butylperoxy)hexane; tert-butyl cumyl peroxide; 2,5,-dimethyl-2,5-di(tert-butylperoxy)hexyne-3; di-tert-butyl peroxide; 3,6,9-triethyl-3,6,9-trimethyl-1,4,7-triperoxonane; 1,1,3,3-tetramethylbutyl hydroperoxide; diisopropylbenzene monohydroperoxide; cumyl hydroperoxide; tert-butyl hydroperoxide; tert-amyl hydroperoxide; tert-butyl peroxyisobutyrate; tert-amyl peroxyacetate; tert-butylperoxy stearyl carbonate; di(1-hydroxycyclohexyl) peroxide; ethyl 3,3-di(tert-butylperoxy)butyrate; and tert-butyl 3-isopropenylcumyl peroxide.

Non-limiting examples of crosslinking co-agents include triallyl cyanurate; triallyl isocyanurate; tri(methallyl)-isocyanurate; tris(diallylamine)-s-triazine, triallyl phosphite; N,N-diallyl acrylamide; hexaallyl phosphoramide; N,N,N′,N′-tetraallyl terephthalamide; N,N,N′,N′-tetraallyl malonamide; trivinyl isocyanurate; 2,4,6-trivinyl methyltrisiloxane; and tri(5-norbornene-2-methylene) cyanurate. The crosslinking co-agents preferably contain at least two sites of olefinic unsaturation. The sites of unsaturation react with the free radical generated on the fluorocarbon elastomer molecule and crosslink the elastomer. A commonly used crosslinking agent is triallylisocyanurate (TAIC).

In a preferred embodiment, plasticizers, extender oils, synthetic processing oils, or a combination thereof may be used in the compositions of the invention. The type of processing oil selected will typically be consistent with that ordinarily used in conjunction with the specific rubber or rubbers present in the composition. The extender oils may include, but are not limited to, aromatic, naphthenic, and paraffinic extender oils. Preferred synthetic processing oils include polylinear α-olefins. The extender oils may also include organic esters, alkyl ethers, or combinations thereof. As disclosed in U.S. Pat. No. 5,397,832, it has been found that the addition of certain low to medium molecular weight organic esters and alkyl ether esters to the compositions of the invention lowers the Tg of the polyolefin and rubber components, and of the overall composition, and improves the low temperatures properties, particularly flexibility and strength. These organic esters and alkyl ether esters generally have a molecular weight that is generally less than about 10,000. Particularly suitable esters include monomeric and oligomeric materials having an average molecular weight below about 2000, and preferably below about 600. In one embodiment, the esters may be either aliphatic mono- or diesters or alternatively oligomeric aliphatic esters or alkyl ether esters.

In addition to the elastomeric material, the thermoplastic polymeric material, and curative, the processable rubber compositions of this invention may include other additives such as stabilizers processing aids, curing accelerators, fillers, pigments, adhesives, tackifiers, and waxes. The properties of the compositions and articles of the invention may be modified, either before or after vulcanization, by the addition of ingredients that are conventional in the compounding of rubber, thermoplastics, and blends thereof.

A wide variety of processing aids may be used, including plasticizers and mold release agents. Non-limiting examples of processing aids include Caranuba wax, phthalate ester plasticizers such as dioctylphthalate (DOP) and dibutylphthalate silicate (DBS), fatty acid salts such zinc stearate and sodium stearate, polyethylene wax, and keramide. In some embodiments, high temperature processing aids are preferred. Such include, without limitation, linear fatty alcohols such as blends of C₁₀-C₂₈ alcohols, organosilicones, and functionalized perfluoropolyethers. In some embodiments, the compositions contain about 1 to about 15% by weight processing aids, preferably about 5 to about 10% by weight.

Acid acceptor compounds are commonly used as curing accelerators or curing stabilizers for the peroxide curing system. Preferred acid acceptor compounds include oxides and hydroxides of divalent metals. Non-limiting examples include Ca (OH)₂, MgO, CaO, and ZnO. In various embodiments, ZnO is preferred.

Non-limiting examples of fillers include both organic and inorganic fillers such as, barium sulfate, zinc sulfide, carbon black, silica, titanium dioxide, clay, talc, fiber glass, fumed silica and discontinuous fibers such as mineral fibers, wood cellulose fibers, carbon fiber, boron fiber, and aramid fiber (Kevlar). Some non-limiting examples of processing additives include stearic acid and lauric acid. The addition of carbon black, extender oil, or both, preferably prior to dynamic vulcanization, is particularly preferred. Non-limiting examples of carbon black fillers include SAF black, HAF black, SRP black and Austin black. Carbon black improves the tensile strength, and an extender oil can improve processability, the resistance to oil swell, heat stability, hysteresis, cost, and permanent set. In a preferred embodiment, fillers such as carboxy block may make up to about 40% by weight of the total weight of the compositions of the invention. Preferably, the compositions comprise 1-40 weight % of filler. In other embodiments, the filler makes up 10 to 25 weight % of the compositions.

In preferred embodiments, the vulcanized elastomeric material, also referred to herein generically as a “rubber,” is present as small particles within a continuous thermoplastic polymer matrix. Depending on the relative viscosities of the elastomer and thermoplastic phases and other parameters, a phase structure where the thermoplastic is a continuous phase is normally observed when the thermoplastic is above about 20% or the total weight of thermoplastic plus elastomer. A co-continuous morphology is also possible depending on the amount of elastomeric material relative to thermoplastic material, the cure system, and the mechanism and degree of cure of the elastomer and the amount and degree of mixing. Preferably, the elastomeric material is fully crosslinked/cured.

The full crosslinking can be achieved by adding an appropriate curative or curative system to a blend of thermoplastic material and elastomeric material, and vulcanizing the rubber to the desired degree under conventional vulcanizing conditions. In a preferred embodiment, the elastomer is crosslinked by the process of dynamic vulcanization. The term dynamic vulcanization refers to a vulcanization or curing process for a rubber contained in a thermoplastic composition, wherein the curable rubber is vulcanized under conditions of high shear at a temperature above the melting point of the thermoplastic component. The rubber is thus simultaneously crosslinked and dispersed as particles within the thermoplastic matrix. In various embodiments, dynamic vulcanization is effected by mixing the elastomeric and thermoplastic components at elevated temperature in the presence of a curative in conventional mixing equipment such as roll mills, Moriyama mixers, Banbury mixers, Brabender mixers, continuous mixers, mixing extruders such as single and twin-screw extruders, and the like. An advantageous characteristic of dynamically cured compositions is that, notwithstanding that the elastomeric component is cured, the compositions can be processed and reprocessed by conventional plastic processing techniques such as extrusion, injection molding and compression molding. Scrap or flashing can be salvaged and reprocessed.

Heating and mixing or mastication at vulcanization temperatures are generally adequate to complete the vulcanization reaction in a few minutes or less, but if shorter vulcanization times are desired, higher temperatures and/or higher shear may be used. A suitable range of vulcanization temperature is from about the melting temperature of the thermoplastic material (which is preferably about 120° C. or higher, more preferably 150° C. or higher) to about 300° C. or more. Without limitation, the range is from about 150° C. to about 250° C. A preferred range of vulcanization temperatures is from about 180° C. to about 220° C. It is preferred that mixing continue without interruption until vulcanization occurs or is complete.

If appreciable curing is allowed after mixing has stopped, an unprocessable thermoplastic vulcanizate may be obtained. In this case, a kind of post curing step may be carried out to complete the curing process. In some embodiments, the post curing takes the form of continuing to mix the elastomer and thermoplastic during a cool-down period.

After dynamic vulcanization, a homogeneous mixture is obtained, wherein the rubber is in the form of small dispersed particles essentially of an average particle size smaller than about 50 μm, preferably of an average particle size smaller than about 25 μm, more preferably of an average size smaller than about 10 μm or less, and still more preferably of an average particle size of 5 μm or less.

The progress of the vulcanization can be followed by monitoring mixing torque or mixing energy requirements during mixing. The mixing torque or mixing energy curve generally goes through a maximum after which mixing can be continued somewhat longer to improve the fabricability of the blend. If desired, one can add additional ingredients, such as the stabilizer package, after the dynamic vulcanization is complete. The stabilizer package is preferably added to the thermoplastic vulcanizate after vulcanization has been essentially completed, i.e., the curative has been essentially consumed.

The processable rubber compositions of the invention may be manufactured in a batch process or a continuous process.

In a batch process, predetermined charges of elastomeric material, thermoplastic material and curative agents are added to a mixing apparatus. In a typical batch procedure, the elastomeric material and thermoplastic material are first mixed, blended, masticated or otherwise physically combined until a desired particle size of elastomeric material is provided in a continuous phase of thermoplastic material. When the structure of the elastomeric material is as desired, a curing system containing the radical initiator and crosslinking co-agent is then added while continuing to apply mechanical energy to mix the elastomeric material and thermoplastic material. Curing is effected by heating or continuing to heat the mixing combination of thermoplastic and elastomeric material in the presence of the curative agent. Following cure, the processable rubber composition is removed from the reaction vessel (mixing chamber) for further processing.

It is preferred to mix the elastomeric material and thermoplastic material at a temperature where the thermoplastic material softens and flows. If such a temperature is below that at which the curative agent is activated, the curative agent may be a part of the mixture during the initial particle dispersion step of the batch process. In some embodiments, a curative is combined with the elastomeric and polymeric material at a temperature below the curing temperature. When the desired dispersion is achieved, the temperature may be increased to effect cure. However, if the curative agent is activated at the temperature of initial mixing, it is preferred to leave out the curative until the desired particle size distribution of the elastomeric material in the thermoplastic matrix is achieved. In another embodiment, curative is added after the elastomeric and thermoplastic materials are mixed. Thereafter, in a preferred embodiment, the curative agent is added to a mixture of elastomeric particles in thermoplastic material while the entire mixture continues to be mechanically stirred, agitated or otherwise mixed.

Continuous processes may also be used to prepare the processable rubber compositions of the invention. In a preferred embodiment, a twin screw extruder apparatus, either co-rotation or counter-rotation screw type, is provided with ports for material addition and reaction chambers made up of modular components of the twin screw apparatus. In a typical continuous procedure, thermoplastic material and elastomeric material are combined by inserting them into the screw extruder together in a first hopper using a feeder (loss-in-weight or volumetric feeder). Temperature and screw parameters may be adjusted to provide a proper temperature and shear to effect the desired mixing and particle size distribution of an uncured elastomeric component in a thermoplastic material matrix. The duration of mixing may be controlled by providing a longer or shorter length of extrusion apparatus or by controlling the speed of screw rotation for the mixture of elastomeric material and thermoplastic material to go through during the mixing phase. The degree of mixing may also be controlled by the mixing screw element configuration in the screw shaft, such as intensive, medium or mild screw designs. Then, at a downstream port, by using side feeder (loss-in-weight or volumetric feeder), the curative agent may be added continuously to the mixture of thermoplastic material and elastomeric material as it continues to travel down the twin screw extrusion pathway. Downstream of the curative additive port, the mixing parameters and transit time may be varied as described above. By adjusting the shear rate, temperature, duration of mixing, mixing screw element configuration, as well as the time of adding the curative agent, processable rubber compositions of the invention may be made in a continuous process.

The compositions and articles of the invention will contain a sufficient amount of vulcanized elastomeric material (“rubber”) to form a rubbery composition of matter, that is, they will exhibit a desirable combination of flexibility, softness, and compression set. Preferably, the compositions should comprise at least about 25 parts by weight rubber, preferably at least about 35 parts by weight rubber, even more preferably at least about 45 parts by weight rubber, and still more preferably at least about 50 parts by weight rubber per 100 parts by weight of the rubber and thermoplastic polymer combined. More specifically, the amount of cured rubber within the thermoplastic vulcanizate is generally from about 5 to about 95 percent by weight, preferably from about 35 to about 85 percent by weight, and more preferably from about 50 to about 80 percent by weight of the total weight of the rubber and the thermoplastic polymer combined.

The amount of thermoplastic polymer within the processable rubber compositions of the invention is generally from about 5 to about 95 percent by weight, more preferably from about 5 to about 80 percent by weight, preferably from about 15 to about 65 percent by weight and more preferably from about 20 to about 50 percent by weight of the total weight of the rubber and the thermoplastic combined.

As noted above, the processable rubber compositions and shaped articles of the invention include a cured rubber and a thermoplastic polymer. Preferably, the thermoplastic vulcanizate is a homogeneous mixture wherein the rubber is in the form of finely-divided and well-dispersed rubber particles within a non-vulcanized matrix. It should be understood, however, that the thermoplastic vulcanizates of the this invention are not limited to those containing discrete phases inasmuch as the compositions of this invention may also include other morphologies such as co-continuous morphologies. In especially preferred embodiments, the rubber particles have an average particle size smaller than about 50 μm, more preferably smaller than about 25 μm, even more preferably smaller than about 10 μm or less, and still more preferably smaller than about 5 μm.

The term vulcanized or cured rubber refers to a natural or synthetic rubber that has undergone at least a partial cure. The degree of cure can be measured by determining the amount of rubber that is extractable from the thermoplastic vulcanizate by using boiling xylene or cyclohexane as an extractant. This method is disclosed in U.S. Pat. No. 4,311,628. By using this method as a basis, the cured rubber of this invention will have a degree of cure where not more than 15 percent of the rubber is extractable, preferably not more than 10 percent of the rubber is extractable, and more preferably not more than 5 percent of the rubber is extractable. In an especially preferred embodiment, the elastomer is technologically fully vulcanized. The term fully vulcanized refers to a state of cure such that the crosslinked density is at least 7×10⁻⁵ moles per ml of elastomer or that the elastomer is less than about three percent extractable by cyclohexane at 23° C.

The degree of cure can be determined by the cross-link density of the rubber. This, however, must be determined indirectly because the presence of the thermoplastic polymer interferes with the determination. Accordingly, the same rubber as present in the blend is treated under conditions with respect to time, temperature, and amount of curative that result in a fully cured product as demonstrated by its cross-link density. This cross-link density is then assigned to the blend similarly treated. In general, a cross-link density of about 7×10⁻⁵ or more moles per milliliter of rubber is representative of the values reported for fully cured elastomeric copolymers. Accordingly, it is preferred that the compositions of this invention are vulcanized to an extent that corresponds to vulcanizing the same rubber as in the blend statically cured under pressure in a mold with such amounts of the same curative as in the blend and under such conditions of time and temperature to give a cross-link density greater than about 7×10⁻⁵ moles per milliliter of rubber and preferably greater than about 1×10⁻⁴ moles per milliliter of rubber.

Advantageously, the shaped articles of the invention are rubber-like materials that, unlike conventional rubbers, can be processed and recycled like thermoplastic materials. These materials are rubber like to the extent that they will retract to less than 1.5 times their original length within one minute after being stretched at room temperature to twice its original length and held for one minute before release, as defined in ASTM D1566. Also, these materials satisfy the tensile set requirements set forth in ASTM D412, and they also satisfy the elastic requirements for compression set per ASTM D395.

The reprocessability of the rubber compositions of the invention may be exploited to provide a method for reducing the costs of a manufacturing process for making shaped rubber articles. The method involves recycling scrap generated during the manufacturing process to make other new shaped articles. Because the compositions of the invention and the shaped articles made from the compositions are thermally processable, scrap may readily be recycled for re-use by collecting the scrap, optionally cutting, shredding, grinding, milling, otherwise comminuting the scrap material, and re-processing the material by conventional thermoplastic techniques. Techniques for forming shaped articles from the recovered scrap material are in general the same as those used to form the shaped articles—the conventional thermoplastic techniques include, without limitation, blow molding, injection molding, compression molding, and extrusion.

The re-use of the scrap material reduces the costs of the manufacturing process by reducing the material cost of the method. Scrap may be generated in a variety of ways during a manufacturing process for making shaped rubber articles. For example, off-spec materials may be produced. Even when on-spec materials are produced, manufacturing processes for shaped rubber articles tend to produce waste, either through inadvertence or through process design, such as the material in sprues of injection molded parts. The re-use of such materials through recycling reduces the material and thus the overall costs of the manufacturing process.

For thermoset rubbers, such off spec materials usually can not be recycled into making more shaped articles, because the material can not be readily re-processed by the same techniques as were used to form the shaped articles in the first place. Recycling efforts in the case of thermoset rubbers are usually limited to grinding up the scrap and the using the grinds as raw material in a number products other than those produced by thermoplastic processing technique.

The present invention is further illustrated through the following non-limiting examples.

### EXAMPLES

LTFE is a peroxide curable base resistant elastomer from Dyneon. It is a low temperature rubber based on a copolymer containing a perfluorovinylether and cure sites reactive with peroxide.

GLT is a peroxide curable fluorocarbon elastomer with cure site monomers, from DuPont/Dow. It is based on a copolymer of tetrafluoroethylene, vinylidene fluoride, and perfluoromethylvinylether. Commercially embodiments include Viton® 200SL and Viton® GLT 600S.

P757 is Tecnoflon® P757, a peroxide curable fluoroelastomer with cure sites from Solvay.

MP-10 is Hylar® MP-10, a polyvinylidene fluoride thermoplastic polymer from Solvay.

Flex is Kynar® Flex 2500-20, a polyvinylidene fluoride based thermoplastic polymer from Atofina. It is based on a vinylidene fluoride copolymer.

Pebax is Pebax® MX 1205, a polyamide/polyether thermoplastic elastomer from Arkema.

Luperox® 101XL45 is a peroxide initiator from Arkema.

TAIC is triallylisocyanurate.

The examples based on 100% rubber are prepared by blending the following according the manufacturer's instructions.

| | |
|---|---|
| rubber (P757, GLT or LTFE): | 100 pph |
| Luperox 101XL45: | 3 pph |
| TAIC: | 3 pph |
| ZnO: | 3 pph |
| Carbon black: | 30 pph |

The rubber is cured in a mold for 7 minutes at 177° C., and post-cured 16 hours at 232° C.

The Examples based on 0% rubber are run on the thermoplastic itself (MP-10, Flex or Pebax).

Examples 1a through 4c are made by dynamic vulcanization of a fluorocarbon elastomer (GLT or LTFE) with a radical curing system (Luperox 101XL45, triallylisocyanurate, and ZnO) in the presence of a thermoplastic (Hylar MP 10 or Kynar Flex 2500-20,). Examples 5 and 6 are made by dynamic vulcanization of P757 in either Flex or Pebax, respectively.

In a batch process, the peroxide curable elastomer (P757, GLT, or LTFE) and the thermoplastic (MP-10, Pebax, or Flex) are mixed and melted in a Brabender or Banbury type batch mixer at 160° C. for 5 minutes. The zinc oxide and carbon black are then stirred in. A curative package consisting of Luperco 101 XL and TAIC is added to the mixer and stirred for an additional 3-5 minutes at 160° C. to form a fully cured thermoplastic vulcanizate. The composition is then discharged from the batch mixer and granulated to make small size pellets for use in subsequent shaped article fabrication processes, such as injection molding, compression molding, blow molding, single layer extrusion, multi-layer extrusion, insert molding, and the like.

A continuous process is carried out in a twin-screw extruder. Pellets of fluoroelastomer (P757, GLT, or LTFE) and thermoplastic (Pebax, MP-10, or Flex ) are mixed and added to a hopper. The pellets are fed into the barrel, which is heated to 160° C. The screw speed is 100-200 rpm. A curative package consisting of Luperco 101 XL, TAIC, ZnO and carbon black is then fed into the barrel at a downstream port located about one third of the total barrel length from the extruder exit. The ingredients are melted and blended with the molten elastomer and fluoroplastic mixture for a time determined by the screw speed and the length of the barrel. For example, the residence time is about 4-5 minutes at 100 rpm and about 2-2.5 minutes at 200 rpm. The cured material is extruded through 1-3 mm diameter strand die and is quenched by cooling in a water bath before passing through a strand pelletizer. The pellets are be processed by a wide variety of thermoplastic techniques into molded articles. The material is also being formed into plaques for the measurement of physical properties.

Low temperature properties of the samples are determined by measuring T10 and T100 according to ASTM D-1053-92a.

Dynamic vulcanizates with rubber/thermoplastic ratios from 80/20 to 50/50 are made with the formulations 1a-4c in Table 1. Formulations 5a-6d is given in Table 2.

TABLE 1

| | 1a | 1b | 1c | 2a | 2b | 2c | 3a | 3b | 3c | 4a | 4b | 4c |
|---|---|---|---|---|---|---|---|---|---|---|---|---|
| GLT | 100 | 100 | 100 | 100 | 100 | 100 | | | | | | |
| LTFE | | | | | | | 100 | 100 | 100 | 100 | 100 | 100 |
| Flex | 25 | 50 | 100 | | | | 25 | 50 | 100 | | | |
| MP-10 | | | | 25 | 50 | 100 | | | | 25 | 50 | 100 |
| Luperox 101XL45 | 3 | 3 | 3 | 3 | 3 | 3 | 3 | 3 | 3 | 3 | 3 | 3 |
| TAIC | 3 | 3 | 3 | 3 | 3 | 3 | 3 | 3 | 3 | 3 | 3 | 3 |
| ZnO | 3 | 3 | 3 | 3 | 3 | 3 | 3 | 3 | 3 | 3 | 3 | 3 |
| Carbon black | 10 | 10 | 10 | 10 | 10 | 10 | 10 | 10 | 10 | 10 | 10 | 10 |
| Graphite | 5 | 5 | 5 | 5 | 5 | 5 | 5 | 5 | 5 | 5 | 5 | 5 |
| Silicate fiber | 15 | 15 | 15 | 15 | 15 | 15 | 15 | 15 | 15 | 15 | 15 | 15 |
| T100 | | | | | | | | | | | | |

TABLE 2

| | 5a | 5b | 5c | 5d | 5e | 6a | 6b | 6c | 6d |
|---|---|---|---|---|---|---|---|---|---|
| P757 | 100 | 100 | 100 | 100 | 100 | 100 | 100 | 100 | 100 |
| Pebax | 25 | 50 | 75 | 100 | 125 | | | | |
| Flex | | | | | | | 25 | 50 | 100 |
| Luperox | 3 | 3 | 3 | 3 | 3 | 3 | 3 | 3 | 3 |
| TAIC | 3 | 3 | 3 | 3 | 3 | 3 | 3 | 3 | 3 |
| ZnO | 5 | 5 | 5 | 5 | 5 | 5 | 5 | 5 | 5 |
| Carbon | 10 | 10 | 10 | 10 | 10 | 10 | 10 | 10 | 10 |
| black | | | | | | | | | |

Low temperature stiffness (T100, determined according to ASTM D-1053-92a) is reported in Table 3. T100 of the formulations with rubber-thermoplastic ratio greater than 80/20 are seen to be significantly lower than either of the pure rubber or the pure thermoplastic.

TABLE 3
Table 3. T100 (° C.) of rubber/thermoplastic dynamic vulcanizate blends.

| | Rubber/thermoplastic | | | | |
|---|---|---|---|---|---|
| | 100/0 | 80/20 | 67/33 | 50/50 | 0/100 |
| Ex 1 GLT/Flex) | −35 | −39 | −80 | −82 | −50 |
| Ex 2 (GLT/PVDF) | −35 | −40 | −50 | −52 | −10 |
| Ex 3 (LTFE/Flex) | −35 | −49 | −90 | −95 | −50 |
| Ex 4 (LTFE/PVDF) | −35 | −50 | −55 | −58 | −10 |
| Ex 5 (P757/Pebax) | −25 | −38 | −89 | −92 | −57 |

The examples and other embodiments described herein are exemplary and not intended to be limiting in describing the full scope of compositions and methods of this invention. Equivalent changes, modifications and variations of specific embodiments, materials, compositions and methods may be made with substantially similar results.

We claim:

1. A processable rubber composition comprising a vulcanized elastomeric material dispersed in a matrix: wherein the vulcanized elastomeric material comprises a peroxide cured fluorocarbon elastomer comprising repeating units derived from (a) at least one fluorine-containing olefinic monomer, and (b) from at least one cure site monomer comprising at least one of a C—Cl bond, a C—Br bond, a C—I bond, and an olefin; and wherein the matrix comprises a thermoplastic polymeric material.

2. A composition according to claim 1, wherein the fluorocarbon elastomer comprises repeating units derived from a perfluorovinyl ether.

3. A composition according to claim 1, wherein the matrix forms a continuous phase of the composition, and the composition comprises from about 20 to about 80% by weight of the vulcanized elastomeric material, based on the total weight of elastomer and thermoplastic.

4. A composition according to claim 3, comprising from about 30 to about 80% by weight of the vulcanized elastomeric material.

5. A composition according to claim 4, comprising from about 40 to about 70% by weight of the vulcanized elastomeric material.

6. A composition according to claim 1, wherein the vulcanized elastomeric material comprises repeating units derived from vinylidene difluoride and from a perfluoroalkylvinylether with 1 to 8 carbons in the perfluoroalkyl group.

7. A composition according to claim 1, wherein the vulcanized elastomeric material comprises repeating units derived from tetrafluoroethylene, hexafluoropropylene, and vinylidene fluoride.

8. A composition according to claim 1, wherein the vulcanized elastomeric material comprises repeating units derived from tetrafluoroethylene and a C₂₋₄ olefin.

9. A composition according to claim 1, wherein the vulcanized elastomeric material comprises repeating units derived from perfluoromethylvinylether or perfluoropropylvinylether.

10. A composition according to claim 1, wherein the thermoplastic polymeric material comprises a fluoroplastic.

11. A shaped article prepared by thermoplastic processing of a composition according to claim 1.

12. A rubber sealing member according to claim 11.

13. An O-ring according to claim 11.

14. A gasket according to claim 11.

15. A shaped article prepared by thermoplastic processing of a processable rubber composition comprising a cured fluorocarbon elastomer dispersed in a continuous thermoplastic matrix, wherein the cured fluorocarbon elastomer is cured by a radical curing system and comprises interpolymerized units derived from
(i) tetrafluoroethylene;
(ii) vinylidene fluoride;
(iii) at least one ethylenically unsaturated monomer of the formula
CF₂═CF—CFR_{f},
wherein R_{f} is perfluoroalkyl of 1 to 8 carbon atoms;
(iv) a cure site monomer comprising at least one functional group selected from the group consisting of a C—Cl bond, a C—Br bond, a C—I bond, and an olefin.

16. A shaped article according to claim 15, wherein the cured fluoropolymer comprises interpolymerized units derived from
from about 20 to about 50% by wt. of (i);
from about 10 to about 35% by wt. of (ii);
from about 20 to about 50% by wt. of (iii); and
from about 0.1 to about 5% by wt. of a perfluorovinyl ether of the formula
CF₂═CF—(OCF₂CF(R_{f}))ₐOR′_{f};
wherein R_{f} is perfluoroalkyl of 1 to 8 carbon atoms, R′_{f} is perfluoroalkyl or perfluoroalkoxyalkyl of 1 to 8 carbons, and a is from 0 to 3.

17. A shaped article according to claim 15, wherein the cured fluoropolymer comprises interpolymerized units derived from
from about 30 to about 46% by wt. of (i);
from about 15 to about 30% by wt. of (ii);
from about 25 to about 45% by wt. of (iii); and
from about 0.2 to about 4% by wt. of a perfluorovinyl ether of the formula
CF₂═CF—(OCF₂CF(R_{f}))ₐOR′_{f};
wherein R_{f} is perfluoroalkyl of 1 to 8 carbon atoms, R′_{f} is perfluoroalkyl or perfluoroalkoxyalkyl of 1 to 8 carbons, and a is from 0 to 3.

18. A shaped article according to claim 15, wherein the cured fluoropolymer comprises intempolymerized units derived from
from about 33 to about 46% by wt. of (i);
from about 17 to about 28% by wt. of (ii);
from about 26 to about 42% by wt. of (iii); and
from about 0.2 to about 4% by wt. of a perfluorovinyl ether of the formula
CF₂═CF—(OCF₂CF(R_{f}))ₐOR′_{f};
wherein R_{f} is perfluoroalkyl of 1 to 8 carbon atoms, R′_{f} is perfluoroalkyl or perfluoroalkoxyalkyl of 1 to 8 carbons, and a is from 0 to 3.

19. A shaped article according to claim 16, wherein a is 1 to 3.

20. A shaped article according to claim 16, wherein the perfluorovinylether is selected from the group consisting of

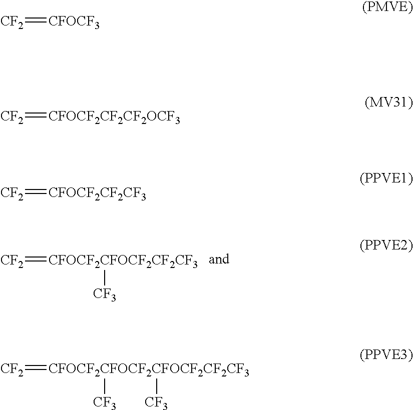

21. A shaped article according to claim 16, wherein the perfluorovinylether comprises at least one ether selected from the group consisting of PPVE1 and PPVE2.

22. A shaped article according to claim 15, wherein the thermoplastic matrix comprises a fluoroplastic.

23. A shaped article according to claim 22, wherein the thermoplastic comprises a polymer or copolymer of vinylidene fluoride.

24. A shaped article according to claim 22, wherein the fluoroplastic comprises a polymer of ethylene and chlorotrifluoroethylene.

25. A gasket according to claim 15.

26. An O-ring according to claim 15.

27. A method for improving the low temperature properties of a composition comprising a cured fluorocarbon elastomer, wherein the cured fluorocarbon elastomer is cured with a radical curing system, the method comprising
dynamically vulcanizing a fluorocarbon elastomer comprising radical cure sites and repeating units derived from at least one fluorine containing olefinic monomer in the presence of a thermoplastic polymeric material and a radical curing system to form a processable rubber composition comprising from 20-80% by weight of the cured fluorocarbon elastomer, based on the total weight of elastomer and thermoplastic.

28. A method according to claim 27, wherein the fluorocarbon elastomer comprises repeating units derived from a perfluorovinylether.

29. A method according to claim 27, wherein the processable rubber composition comprises from about 30 to about 80% by weight of the cured fluorocarbon elastomer, based on the total weight of elastomer and thermoplastic.

30. A method according to claim 27, wherein the processable rubber composition comprises from about 40 to about 70% by weight of the cured fluorocarbon elastomer, based on the total weight of elastomer and thermoplastic.

31. A method according to claim 27, wherein the fluorocarbon elastomer comprises a copolymer of vinylidene fluoride.

32. A method according to claim 27, wherein the fluorocarbon elastomer comprises a copolymer of tetrafluoroethylene and a C₂₋₄ olefin.

33. A method according to claim 27, wherein the radical curing system comprises an organic peroxide and a crosslinking co-agent comprising at least two olefin functional groups.

34. A method according to claim 27, wherein the fluorocarbon elastomer comprises repeating units derived from
from about 20 to about 50% by weight tetrafluoroethylene;
from about 10 to about 35% by weight vinylidene fluoride;
from about 20 to about 50% by weight CF₂═CF—R_{f} where R_{f} is perfluoroalkyl of 1 to 8 carbons;
from about 0.1 to about 15% by weight of a perfluorovinylether; and
from about 0.1 to about 5% by weight of a cure site monomer comprising at least one of a C—Cl bond, C—Br bond, C—I bond, and an olefin.

35. A method according to claim 27, wherein the thermoplastic polymeric material comprises a fluoroplastic.

36. A method according to claim 34, wherein the fluoroplastic comprises a polymer of vinylidene fluoride.

37. A shaped article prepared by thermoplastic processing of a processable rubber composition, the rubber composition comprising a cured fluorocarbon elastomer dispersed in a continuous matrix comprising a thermoplastic material, wherein the cured fluorocarbon elastomer is cured by a radical system and comprises interpolymerized units derived from
(a) a perfluorovinyl ether;
(b) at least one fluorine containing olefinic monomer other than the perfluorovinyl ether; and
(c) a cure site monomer comprising at least one functional group selected from the group consisting of a C—Cl bond, a C—Br bond, a C—I bond, and an olefin.

38. A shaped article according to claim 37, wherein the processable rubber composition is a product of dynamic vulcanization of the elastomer in the presence of the thermoplastic material.
